(19) United States
(12) Patent Application Publication
(10) Pub. No.: US 2014/0124638 A1
(43) Pub. Date: May 8, 2014

(54) CONTAINER HOLDER DEVICE

(71) Applicant: TOYODA GOSEI CO., LTD., Kiyosu-shi (JP)

(72) Inventors: Hajime TAKAI, Kiyosu-shi (JP); Mitsuo OGURA, Kiyosu-shi (JP)

(73) Assignee: TOYODA GOSEI CO., LTD., Kiyosu-shi (JP)

(21) Appl. No.: 14/061,797

(22) Filed: Oct. 24, 2013

(30) Foreign Application Priority Data
Nov. 2, 2012 (JP) 2012-242531

(51) Int. Cl. F16M 13/02

(52) U.S. Cl. CPC F16M 13/02
USPC 248/311.2

(57) ABSTRACT

A support member of a container holder device is configured by a support base unit; a support movable unit, which is held by the support base unit and displaces between an evacuated position and a developed position; and a development urging unit that urges the support movable unit toward the developed position; where a holding end of the support movable unit projects out from the support base unit toward an interior of the case body at the developed position, an end of the support movable unit is directed toward a bottom of the case body at the evacuated position, and the holding end is directed toward an opening of the case body at the developed position.

### BACKGROUND OF THE INVENTION

1. Technical Field

The present invention relates to a container holder device arranged in a vehicle or the like and configured to hold a beverage container or the like.

2. Background Art

A container holder device including a portion (referred to as case body) for accommodating a container and a portion (referred to as support member) for holding the side surface of the container accommodated in the case body is known. In this type of container holder device, the support member is generally attached to the case body, and has a support movable unit. The general support movable unit can be developed in an accommodation space formed inside the case body, and can be evacuated from the accommodation space.

The support movable unit holds the side surface of the container at a developed position where the support movable unit is developed in the accommodation space. A tall container such as a plastic bottle can be stably held by arranging a portion (holding end), which makes contact with the side surface of the container in the support movable unit, at a position close to an upper end (top part) of the container. In order to bring the holding end closer to the top part of the container, it is assumed to be preferable to direct the holding end of the support movable unit toward an opening of the case body (hereinafter simply referred to as the support movable unit facing upward) at the developed position (see, for example, JP 2004-161168 A and JP 07-33740 U).

The support movable unit of the general container holder device is directly or indirectly held by the case body, and swings. The support movable unit is urged toward the developed position, and swings from the developed position toward the evacuated position by being pushed by the container inserted into the container holder device. If the container has a sufficiently small diameter, the support movable unit makes contact with the side surface of the container at a position (referred to as intermediate position) between the developed position and the evacuated position to hold the side surface of the container. If the container has a large diameter, the support movable unit swings to the evacuated position and does not interfere with the side surface of the container. In the container holder device having this type of support member, the containers of various diameters can be stably held by changing the amount of support movable unit exposed to the accommodation space.

The exposed amount of the support movable unit to the accommodation space (hereinafter simply referred to as exposed amount of the support movable unit) differs depending on the state of the support movable unit. For example, when the support movable unit is facing upward at the developed position, the exposed amount of the support movable unit at the intermediate position becomes large compared to the exposed amount of the support movable unit at the developed position. In other words, the exposed amount of the support movable unit gradually becomes larger after the container starts to be inserted into the container holder device.

That is, when the container having a large diameter is inserted into the case body in the conventional container holder device in which the support movable unit faces upward, the support movable unit interferes with the side surface of the container in the middle of the insertion, and the support movable unit may not displace to the evacuated position. This causes a problem that it becomes difficult to stably hold the container with the container holder device arises.

Furthermore, for example, if the user inserts the container into the container holder device with one hand while holding down the support movable unit at the evacuated position with the other hand, the interference of the support movable unit with respect to the side surface of the container can be avoided. In this case, however, the operation of inserting the container becomes cumbersome.

### SUMMARY OF THE INVENTION

### Problem to be Solved by the Invention

The object of the present invention is to provide a container holder device, which includes a support member capable of holding the side surface of the container at a position relatively close to the top part of the container, and to which a container having a relatively large diameter can be easily inserted.

### Means for Solving the Problem

A container holder device of the present invention for solving the problem described above includes a case body having a box shape, and a support member arranged inside the case body, wherein

the support member includes,

a support base unit having a frame shape and being held by the case body,

a support movable unit held by the support base unit, and displaced between an evacuated position where at least a part of the support movable unit is stored in an interior of the support base unit and a developed position where an exposed amount to the inside of the case body is greater than that of the evacuated position, and

a development urging unit that urges the support movable unit toward the developed position;

the support movable unit includes,

a second pivotally supporting part that slidably engages a first pivotally supporting part formed in the support base unit,

a second guide part that slidably engages a first guide part formed in the support base unit, and

a holding end that projects out from the support base unit toward an interior of the case body at the developed position; the holding end is directed toward a bottom of the case body at the evacuated position, and the holding end is directed toward an opening of the case body opposing the bottom at the developed position; and

one of the first and second pivotally supporting parts has a projection shape and the other of the first and second pivotally supporting parts has a long hole shape, and one of the first and second guide parts has a projection shape and the other of the first and second guide parts has a long hole shape in which at least one part is curved.

The container holder device of the present invention preferably includes (1) or (2) below, and more preferably includes (1) and (2).

(1) The first pivotally supporting part has a projection shape and the first guide part has a long hole shape, and the second pivotally supporting part has a long hole shape and the second guide part has a projection shape.
(2) The exposed amount of the support movable unit at an intermediate position between the developed position and the evacuated position is smaller than or equal to the exposed amount of the support movable unit at the developed position.

### Effects of the Invention

A container holder device of the present invention includes a case body, and a support member arranged inside the case body. The support member includes a support movable unit, and a support base unit for holding the support movable unit, where an accommodation space sectionalized by the case body and the support base unit is formed in the interior of the case body. The support movable unit of the support member displaces between the developed position and the evacuated position. Therefore, the container holder device of the present invention can accommodate the container inside the case body, and can hold the side surface of the container with the support movable unit. Furthermore, the support movable unit directs the holding end toward the opening of the case body at the developed position. That is, the support movable unit faces upward at the developed position. Thus, according to the container holder device of the present invention, the side surface of the container can be held at a position (generally, upper part of the container) relatively close to the top part of the container. Therefore, a relatively tall container can be stably held according to the container holder device of the present invention.

Furthermore, the container holder device of the present invention includes a pivotally supporting part (first pivotally supporting part, second pivotally supporting part) for pivotally supporting the support movable unit at the support base unit, and a guide part (first guide part, second guide part) for guiding the support movable unit so that the support movable unit displaces along a predetermined path. Both the pivotally supporting part and the guide part are configured by a combination of a long hole and a projection. In other words, the support movable unit can pivot biaxially with respect to the support base unit. Thus, according to the container holder device of the present invention, the path of the support movable unit from the developed position to the evacuated position can be made small, and consequently, the exposed amount of the support movable unit at the intermediate position can be made small. That is, according to the container holder device of the present invention, the support movable unit is less likely to interfere with the side surface of the container and the container can be easily inserted even when holding a container having a large diameter.

### BRIEF DESCRIPTION OF THE DRAWINGS

FIG. 1 is a perspective view schematically showing a state in which a support movable unit is arranged at a developed position in a container holder device according to an example;

FIG. 2 is a perspective view schematically showing a state in which the support movable unit is arranged at an evacuated position in the container holder device according to the example;

FIG. 3 is an exploded perspective view schematically showing a support member in the container holder device according to the example;

FIG. 4 is an explanatory view describing the operation of the container holder device according to the example when the support movable unit is arranged at the developed position;

FIG. 5 is an explanatory view describing the operation of the container holder device according to the example when the support movable unit is arranged at an intermediate position; and

FIG. 6 is an explanatory view describing the operation of the container holder device according to the example when the support movable unit is arranged at the evacuated position.

### DETAILED DESCRIPTION OF THE PREFERRED EMBODIMENTS

A container holder device of the present invention will be hereinafter described using a specific example.

### Example

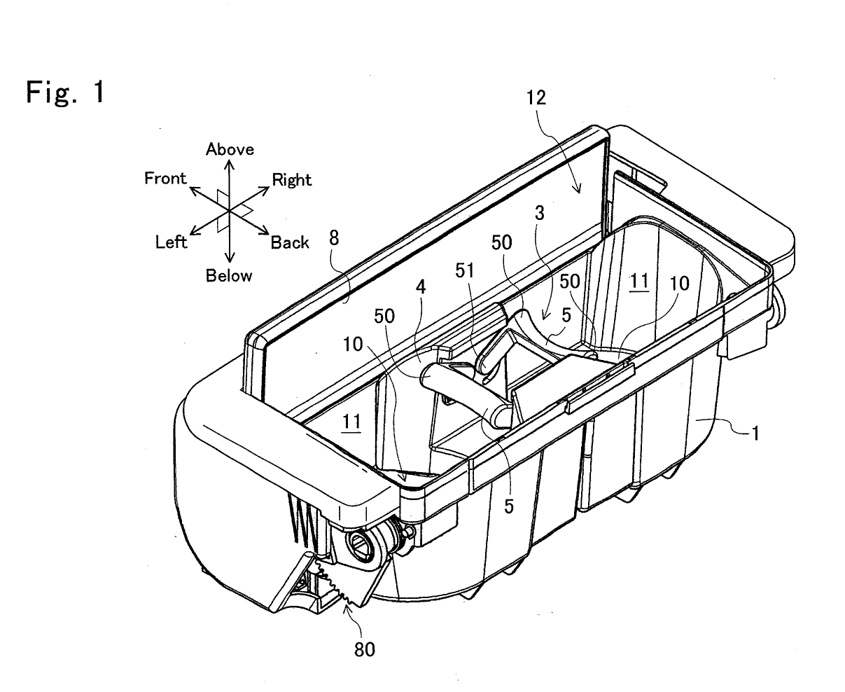

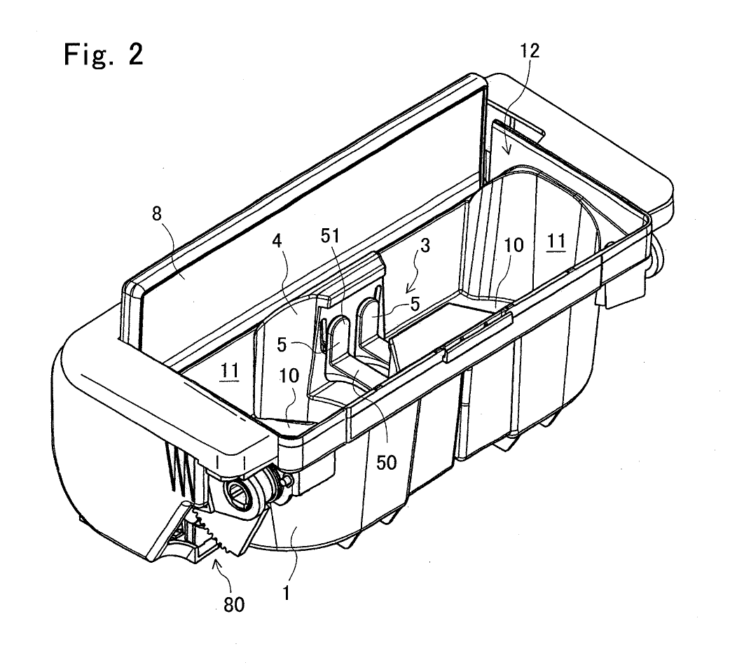

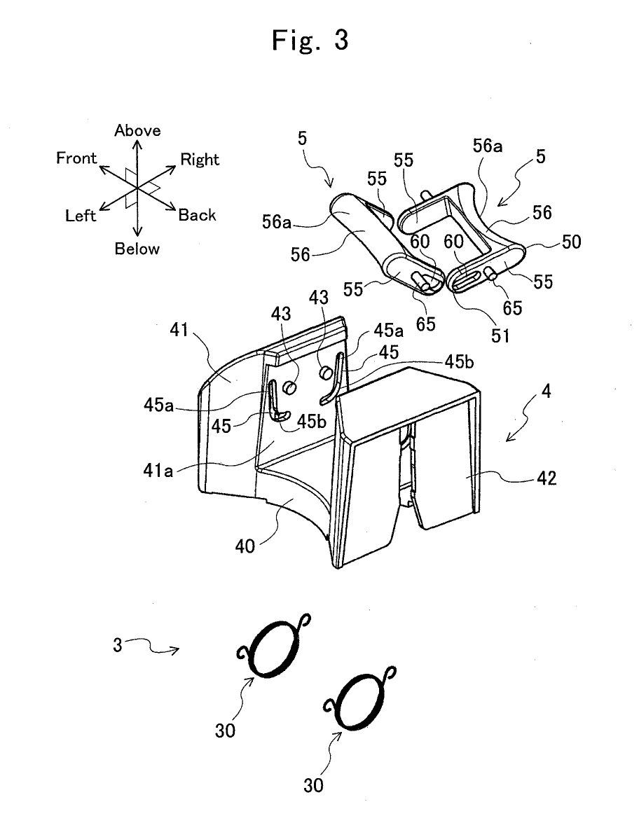

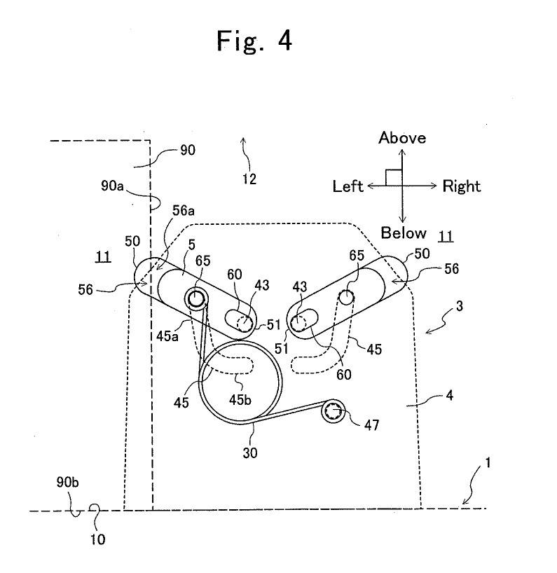

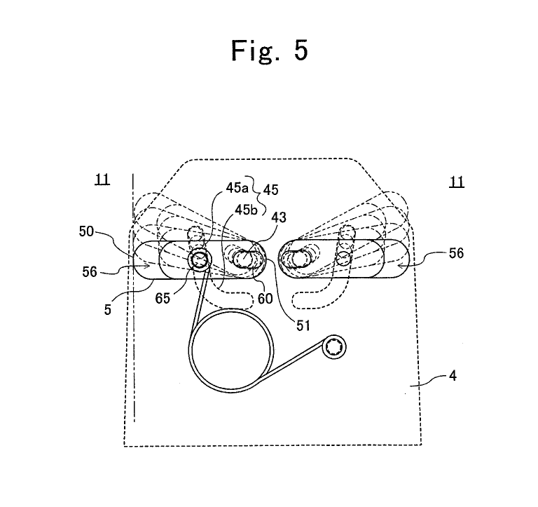

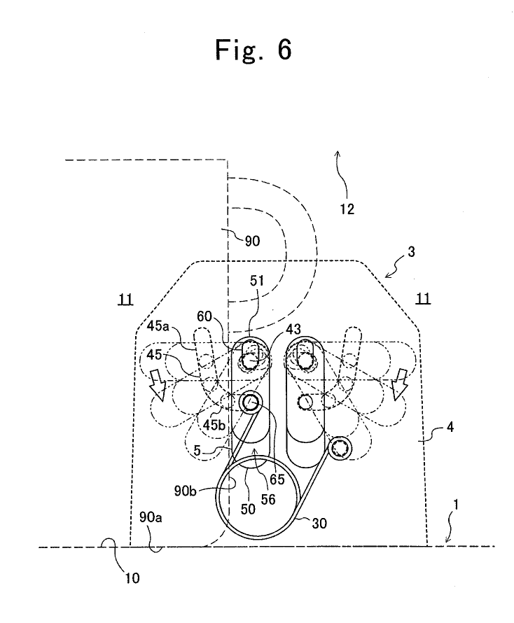

FIGS. 1 and 2 show perspective views schematically showing a container holder device according to an example. FIG. 3 is an exploded perspective view schematically showing a support member in the container holder device according to the example. FIGS. 4 to 6 are explanatory views describing the operation of the container holder device according to the example. More specifically, FIG. 1 shows a state in which the support movable unit is arranged at a developed position, and FIG. 2 shows a state in which the support movable unit is arranged at an evacuated position. FIG. 4 shows a state in which the support movable unit is arranged at the developed position, FIG. 5 shows a state in which the support movable unit is arranged at a position (intermediate position) between the developed position and the evacuated position, and FIG. 6 shows a state in which the support movable unit is arranged at the evacuated position. Hereinafter, above (up), below (down), left, right, front, and back in the example refer to above, below, left, right, front, and back shown in FIG. 1.

As shown in FIG. 1, the container holder device includes a case body 1, a support member 3, and a lid body 8. The case body 1 has a substantially box shape with the upper side opened, and the longitudinal direction is directed in the left and right direction. The support member 3 is arranged inside the case body 1. The lid body 8 is pivotally supported by the case body 1. Although not shown, the lid body 8 can pivot with respect to the case body 1 to open and close an opening 12 of the case body 1. A drive unit 80 for driving at least a part of the open/close operation of the lid body 8 is interposed between the lid body 8 and the case body 1.

As shown in FIG. 3, the support member 3 includes a support base unit 4, two support movable units 5, and two development urging units 30. The support base unit 4 has a substantially U-shaped frame shape, and is fixed to a bottom 10 of the case body 1 with the opening facing the upper side. More specifically, the support base unit 4 includes a base portion 40 that faces the bottom 10 of the case body 1, a first supporting column 41 that is integrated to a front end of the base portion 40 and that extends toward the upper side, and a second supporting column 42 that is integrated to a back end of the base portion 40 and that extends toward the upper side. The first supporting column 41 and the second supporting column 42 respectively have a hollow shape. The first supporting column 41 and the second supporting column 42 also face each other. The left surface and the right surface of the support base unit. 4 respectively have a recessed curved surface shape.

The first supporting column 41 is formed with two first pivotally supporting parts 43, two first guide parts 45, and one urging supporting part 47 (shown in FIGS. 4 to 6). Each first pivotally supporting part 43 has a substantially circular column shape that projects out in a substantially horizontal direction from an inner wall 41a (back wall) of the first supporting column 41 toward the back side. The two first pivotally supporting parts 43 are arranged in the left and right direction, that is, substantially horizontal direction, and are spaced apart from each other. The urging supporting part 47 has a substantially circular column shape that projects out in a substantially horizontal direction to the hollow interior of the first supporting column 41 from the inner wall 41a of the first supporting column 41 toward the front side.

The two first guide parts 45 have a long hole shape formed to pass through the inner wall 41a of the first supporting column 41. One first guide part 45 is arranged on the left side of one first pivotally supporting part 43, and the other first guide part 45 is arranged on the right side of the other first pivotally supporting part 43. That is, the two first guide parts 45 are arranged in the left and right direction, that is substantially horizontal direction, with the two first pivotally supporting parts 43 therebetween. The first guide part 45 is spaced apart from the first pivotally supporting part 43. Each first guide part 45 includes a developing side guide hole 45a that extends in a substantially linear manner, and an evacuating side guide hole 45b that continues to the developing side guide hole 45a and extends in a curved manner.

In the first guide part 45 arranged on the left side in FIG. 3, the developing side guide hole 45a is linearly inclined from the upper left side toward the lower right side. The evacuating side guide hole 45b, on the other hand, is curved to a substantially arcuate shape, with the first pivotally supporting part 43 as the center, further toward the lower right side from the lower right end of the developing side guide hole 45a. In the first guide part 45 arranged on the right side in FIG. 3, the developing side guide hole 45a is linearly inclined from the upper right side toward the lower left side. The evacuating side guide hole 45b is curved to a substantially arcuate shape, with the first pivotally supporting part 43 as the center, further toward the lower left side from the lower left end of the developing side guide hole 45a. That is, the two first guide parts 45 have a symmetrical shape as a bilateral direction. The upper end of the developing side guide hole 45a is positioned on the upper side than the first pivot ally supporting part 43, and the lower end of the evacuating side guide hole 45b is positioned on the lower side than the first pivotally supporting part 43.

Although not shown, the inner wall (front wall) of the second supporting column 42 is also formed with two first guide parts 45 of substantially the same shape as the two first guide parts 45 formed in the first supporting column 41, two first pivotally supporting parts 43 of substantially the same shape as the two first pivotally supporting parts 43 formed in the first supporting column 41, and the urging supporting part 47 of substantially the same shape as the one urging supporting part 47 formed in the first supporting column 41. The two first guide parts 45, the two first pivotally supporting parts 43, and the one urging supporting part 47 formed in the first supporting column 41, and the two first guide parts 45, the two first pivotally supporting parts 43, and the one urging supporting part 47 formed in the second supporting column 42 are arranged front-back symmetrically.

In the interior of the case body 1, an accommodation space 11 for accommodating a container is sectionalized and formed by the support base unit 4 and the case body 1.

Each support movable unit 5 has a substantially U-shaped frame shape as shown in FIGS. 1 to 3, and includes a projecting end 50 that becomes the projection end directed from the support base unit 4 toward the accommodation space 11 at the developed position shown in FIG. 1, and a basal end 51 that is an end on the opposite side of the projecting end 50. Furthermore, as shown in FIG. 3, the support movable unit 5 also includes two legs 55 having a substantially column shape and being arranged substantially parallel to each other, and a substantially column shaped holding end 56 for coupling the two legs 55 on the projecting end 50 side. The holding end 56 has a contacting surface 56a curved to a recessed shape from the projecting end 50 toward the basal end 51. The contacting surface 56a connects the two legs 55. The recessed amount of the contacting surface 56a is a maximum at substantially the middle in a direction of connecting the two legs 55.

As shown in FIG. 4, the contacting surface 56a of the support movable unit 5 makes contact with a side surface 90a of the container 90 when accommodating and holding the container 90. When each support movable unit 5 is held by the support base unit 4, the outer surface (front surface) of one leg 55 faces the inner surface of the first supporting column 41, and the outer surface (back surface) of the other leg 55 faces the inner surface of the second supporting column 42. One support movable unit 5 is arranged on the left side in FIG. 1, and the other support movable unit 5 is arranged on the right side in FIG. 1.

A second pivotally supporting part 60 having a long hole shape, and a second guide part 65 having a substantially circular column shape are respectively formed on the outer surface of the leg 55. The second pivotally supporting part 60 slidably engages with the first pivotally supporting part 43 of the case body 1, and the second guide part 65 slidably engages with the first guide part 45 of the case body 1. Each second guide part 65 is arranged at substantially the middle in the direction of the projecting end 50—the basal end 51 in each leg 55. Furthermore, each second pivotally supporting part 60 is arranged closer to the basal end 51 side than each second guide part 65. The second pivotally supporting part 60 and the second guide part 65 are spaced apart, and the second pivotally supporting part 60 linearly extends along the direction of the projecting end 50—the basal end 51.

The two development urging units 30 are made of torsion spring and respectively have substantially the same shape. One development urging unit 30 is arranged in the interior of the first supporting column 41, and the other development urging unit 30 is arranged in the interior of the second supporting column 42. More specifically, as shown in FIG. 4, one end of the development urging unit 30 is attached to the urging supporting part 47 of the support base unit 4. The other end of the development urging unit 30 is pivotally supported by the second guide part 65 of the support movable unit 5 exposed through the first guide part 45 of the support base unit 4. One development urging portion 30 is attached to one support movable unit 5 and the support base unit 4, and the other development urging unit 30 is attached to the other support movable portion 5 and the support base unit 4. As will be described later, one development urging unit 30 urges one support movable unit 5 toward the developed position, and the other development urging unit 30 urges the other support movable unit 5 toward the developed position.

The operation of the container holder device according to the example will be described below.

At the developed position shown in FIG. 4, the support movable unit 5 directs the holding end 56 toward the opening 12 (upper part in FIG. 4) of the case body 1. That is, the support movable unit 5 faces upward at the developed position. The second guide part 65 is arranged at the upper end of the first guide part 45 (end on the opposite side of the evacuating side guide hole 45b in the developing side guide hole 45a), and the first pivotally supporting part 43 is arranged at the end on the basal end 51 side in the second pivotally supporting part 60. The development urging unit 30 urges the support movable unit 5 toward the developed position. When holding the container 90 having a small diameter in the container holder device of the example, a bottom surface 90b of the container 90 is supported by the bottom 10 of the case body 1 when the container 90 is inserted into the accommodation space 11. The holding end 56 of the support movable unit 5 faces the side surface 90a of the container 90. Since the support movable unit. 5 is arranged at the developed position, the holding end 56 faces the side surface 90a of the container 90 at a position on a relatively upper side. Therefore, the support movable unit 5 in this case supports the side surface 90a of the container 90 at the top part side of the container 90 (opening side of the container, upper side in FIG. 4)e Therefore, the relatively tall container 90 can be stably accommodated and held by the container holder device of the example.

In the case where the container 90 has a relatively large diameter, the support movable unit 5 makes contact with the bottom surface 90b of the container 90 when the container 90 is inserted into the accommodation space 11. The support movable unit 5 is then pushed by the container 90, and displaces from the developed position shown in FIGS. 1 and 4 toward the evacuated position shown in FIGS. 2 and 6.

Specifically, as shown with a chain double dashed line in FIG. 5, the second guide part 65 slides toward the evacuating side guide hole 45b in the developing side guide hole 45a of the first guide part 45 having a long hole shape at an early stage (hereinafter referred to as displacement early stage) in which the support movable unit 5 displaces from the developed position to the evacuated position. The first pivotally supporting part 43 slides in the second pivotally supporting part 60 having a long hole shape from the basal end 51 side toward the projecting end 50 side of the support movable unit 5. The developing side guide hole 45a extends substantially linearly from the accommodation space 11 side and the opening 12 side of the case body 1 toward the center side in the left and right direction of the support base unit 4 and the bottom 10 side of the case body 1. The second pivotally supporting part 60 also has a long hole shape. The support movable unit 5 thus slides while pivoting biaxially with respect to the support base unit 4.

As shown in FIG. 5, the holding end 0.56 of the support movable unit 5 in the example moves substantially linearly in the up and down direction (i.e., direction of opening 11—bottom surface 10 of the case body 1) in the displacement early stage. Thus, in the displacement early stage, the exposed amount of the support movable unit 5 to the accommodation space 11 is substantially constant.

As shown in FIG. 6, the second guide part 65 slides toward the lower end in the evacuating side guide hole 45b of the first guide part 45 having a long hole shape in a late stage (hereinafter simply referred to as displacement late stage) in which the support movable unit 5 displaces from the developed position to the evacuated position. The first pivotally supporting part 43 slides in the second pivotally supporting part 60 having a long hole shape toward the projecting end 50 side. The evacuating side guide hole 45b extends to a substantially elliptical arc shape from the accommodation space 11 side and the opening 12 side of the case body 1 toward the interior side of the support base unit 4 and the bottom 10 side of the case body 1. Thus, the support movable unit 5 slides while pivoting biaxially with the first pivotally supporting part 43 and the second guide part 65 as the center in the displacement late stage as well, but the movement path of the holding end 56 of the support movable unit 5 forms a substantially arcuate shape. That is, the holding end 56 of the support movable unit 5 in the example moves in a curved manner (substantially elliptical arc shape) further toward the interior side of the support base unit 4 and the bottom 10 side of the case body 1 in the displacement late stage than in the displacement early stage. Therefore, the exposed amount of the support movable unit 5 to the accommodation space 11 reduces in the order of developed position=intermediate position of displacement early stage>intermediate position of displacement late stage>evacuated position. That is, in the container holder device of the example, the exposed amount of the support movable unit 5 to the accommodation space 11 at the intermediate position is smaller than or equal to the exposed amount of the support movable unit 5 at the developed position.

At the evacuated position shown in FIG. 6, the support movable unit 5 is stored inside the U-shaped support base unit 4 with the holding end 56 directed toward the bottom 10 side of the case body 1. That is, the support movable unit 5 faces downward at the evacuated position. In this case, the entire support movable unit 5 is stored in the support base unit 4 and the support movable unit 5 is faced downward, so that the holding end 56 of the support movable unit 5 does not interfere with the side surface 90b of the container 90. Thus, in the container holder device of the example, the container 90 having a large diameter is accommodated and held by supporting the bottom surface 90a of the container 90 with the bottom 10 of the case body 1. Furthermore, as described above, the exposed amount of the support movable unit 5 to the accommodation space 11 at the intermediate position is smaller than or equal to the exposed amount of the support movable unit 5 at the developed position. Thus, when inserting the large container 90 into the accommodation space 11, the support movable unit 5 does not interfere with the side surface 90b of the container 90. Therefore, the large container 90 can be easily and stably accommodated and held according to the container holder device of the example.

Furthermore, in the container holder device of the example, when accommodating the large container 90, it is arranged at the evacuated position where the support movable unit 5 is faced downward so that a space forms on the upper side of the support member 3. Thus, when accommodating and holding the large container 90 with a grip such as a mug, and the like with the container holder device of the example, the grip is to be arranged on the upper side of the support member 3. That is, the container holder device of the example can easily and stably accommodate and hold the large container with a grip.

Since the support movable unit 5 is pivoted biaxially with respect to the support base unit 4 in the container holder device of the example, the movement path of the holding end 56 in the displacement early stage is closely related to the shape of the developing side guide hole 45a, and the movement path of the holding end 56 in the displacement late stage is closely related to the shape of the evacuating side guide hole 45b. The developing side guide hole 45a is to be formed to a substantially linear long hole when desiring to move the holding end 56 in a substantially linear manner in the displacement early stage as in the example. The developing side guide hole 45a is to be formed to a substantially curved long hole when desiring to move the holding end 56 in a curved manner in the displacement early stage. The shapes of the developing side guide hole 45a and the evacuating side guide hole 45b are to be appropriately designed according to the movement path of the holding end 56 required on the container holder device.

In the container holder device according to the example, the first pivotally supporting part 43 is a projection, the second pivotally supporting part 60 is a long hole, the first guide part 45 is a long hole, and the second guide part 65 is a projection, but one of the first pivotally supporting part 43 and the second pivotally supporting part 60 merely needs to be formed to a projection shape and the other of them to be formed to a long hole shape, and one of the first guide part 45 and the second guide part 65 merely needs to be formed to a projection shape and the other of them to be formed to a long hole shape in the container holder device of the present invention. For example, the first pivotally supporting part 43 and the first guide part 45 may be formed to a long hole shape, and the second pivotally supporting part 60 and the second guide part 65 may be formed to a projection shape. In order to arrange the first pivotally supporting part 43, the second pivotally supporting part 60, the first guide part 45, and the second guide part 65 in a small space, the first pivotally supporting part 43 is preferably formed to a projection shape, the second pivotally supporting part 60 to a long hole shape, the first guide part 45 to a long hole shape, and the second guide part 65 to a projection shape, similarly to the example.

In the container holder device according to the example, the case body 1 is opened only on the upper side, but the case body 1 in the container holder device of the present invention is not limited thereto. For example, the case body 1 may be opened on the diagonally upper side, opened on the side, or opened at two or more places.

### INDUSTRIAL APPLICABILITY

The container holder device of the present invention can be used as a container holder device to be mounted in a vehicle, for example.

(Others) The present invention is not limited only to the embodiment described above and illustrated in the drawings, and can be implemented by being appropriately changed within a scope not deviating from the gist of the invention.

### DESCRIPTION OF SYMBOLS

1: case body
3: support member
4: support base unit
5: support movable unit
10: bottom of case body
12: opening of case body
30 development urging unit
43: first pivotally supporting part
45: first guide part
56: holding end
60: second pivotally supporting part
65: second guide part

What is claimed is:

1. A container holder device comprising a case body having a box shape, and a support member arranged inside the case body, wherein
the support member includes,
a support base unit having a frame shape and being held by the case body,
a support movable unit held by the support base unit, and displaced between an evacuated position where at least a part of the support movable unit is stored in an interior of the support base unit and a developed position where an exposed amount to the inside of the case body is greater than that of the evacuated position, and
a development urging unit that urges the support movable unit toward the developed position;
the support movable unit includes,
a second pivotally supporting part that slidably engages a first pivotally supporting part formed in the support base unit,
a second guide part that slidably engages a first guide part formed in the support base unit, and
a holding end that projects out from the support base unit toward an interior of the case body at the developed position;
the holding end is directed toward a bottom of the case body at the evacuated position, and the holding end is directed toward an opening of the case body opposing the bottom at the developed position; and
one of the first and second pivotally supporting parts has a projection shape and the other of the first and second pivotally supporting parts has a long hole shape, and one of the first and second guide parts has a projection shape and the other of the first and second guide parts has a long hole shape in which at least one part is curved.

2. The container holder device according to claim 1, wherein the first pivotally supporting part has a projection shape and the first guide part has a long hole shape, and the second pivotally supporting part has a long hole shape and the second guide part has a projection shape.

3. The container holder device according to claim 1, wherein the exposed amount of the support movable unit at an intermediate position between the developed position and the evacuated position is smaller than or equal to the exposed amount of the support movable unit at the developed position.
